(19) United States
(12) Patent Application Publication
(10) Pub. No.: US 2026/0313367 A1
(43) Pub. Date: Oct. 8, 2026

(54) ANONYMIZED USER EQUIPMENT INFORMATION REPORTING

(71) Applicant: Apple Inc., Cupertino, CA (US)

(72) Inventors: Shu Guo, Beijing (CN); Sudeep Manithara Vamanan, Munich (DE); Alexander Sirotkin, Herzliya (IL); Behrouz Aghili, Cupertino, CA (US); Haijing Hu, Cupertino, CA (US)

(73) Assignee: Apple Inc., Cupertino, CA (US)

(21) Appl. No.: 19/481,528

(22) PCT Filed: May 5, 2023
(86) PCT No.: PCT/CN2023/092236

§ 371 Date: Nov. 4, 2025

(51) Int. Cl. H04W 12/02; H04W 72/0453; H04W 72/21

(52) U.S. Cl. CPC H04W 12/02; H04W 72/0453; H04W 72/21

(57) ABSTRACT

The present application relates to devices and components including apparatus, systems, and methods for anonymized user equipment information reporting in wireless communication systems.

### TECHNICAL FIELD

The present application relates to the field of wireless technologies and, in particular, to anonymized user equipment information reporting.

### BACKGROUND

Third Generation Partnership Project (3GPP) networks rely on reports being transmitted between user equipments (UEs) and the network elements of the networks for operation. For example, the UEs and one or more network elements can exchange reports that are utilized for determining operating characteristics for the network, such as locations of the UEs, signaling power for transmissions, and other operating characteristics of the network. Many of these reports include information that can be utilized to identify the specific UEs.

### BRIEF DESCRIPTION OF THE DRAWINGS

FIG. 1 illustrates an example network arrangement in accordance with some embodiments.

FIG. 2 illustrates an example call flow for a service for sending anonymized uplink (UL) data in accordance with some embodiments.

FIG. 3 illustrates an example network arrangement in accordance with some embodiments.

FIG. 4 illustrates an example network arrangement in accordance with some embodiments.

FIG. 5 illustrates an example signaling chart for the first alternative of the third approach using user equipment route selection policy (URSP) rules in accordance with some embodiments.

FIG. 6 illustrates an example signaling chart for the second alternative of the third approach using radio resource control (RRC) signaling in accordance with some embodiments.

FIG. 7 illustrates an example procedure for operating a user equipment (UE) in accordance with some embodiments.

FIG. 8 illustrates an example procedure for operating a base station in accordance with some embodiments.

FIG. 9 illustrates an example procedure for operating a UE in accordance with some embodiments.

FIG. 10 illustrates an example procedure for operating a base station in accordance with some embodiments.

FIG. 11 illustrates an example UE in accordance with some embodiments.

FIG. 12 illustrates an example next generation NodeB (gNB) in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “UE-identifying information” refers to information that may be utilized for identifying a particular UE. In particular, UE-identifying information included in a transmission may include information of the transmission that can be utilized by other entities to identify the particular UE (such as permanent identifiers assigned to the UE, mapping information of temporary identifiers to permanent identifiers assigned to the UE, identifiers associated with component of the UE, data that identifies a user of the UE, or some combination thereof).

For many features, user equipment (UE) has to report privacy sensitive information (for example, UE location along with measurement results) to the third generation partnership project (3GPP) network. For example, a UE may perform measurements and provide measurement reports to the network for proper operation. The measurements reports may include sensitive information that can be utilized for identifying the specific UE. This is not limited to 3GPP features, at least some of the embodiments described herein are designed to provide a generic “anonymous transmission” service which can be used by any application.

The legacy infrastructure is designed such that the information can be linked to the identity of the UE who reports it by various Network Functions in the Core Network.

For example, measurement reports reported to a base station (such as a next generation NodeB (gNB)) can be traced to the UE that sent it. Accordingly, one or more network functions in a core network of a legacy system infrastructure may be able to determine an identity of a UE that provides a report.

In some instances, UE-identifying information included with legacy reporting transmissions may not be required for proper operation of the network. In these instances, the UE-identifying information may be omitted or removed from the reporting transmissions prior to the reporting transmissions being received by certain network functions in the core network while still allowing the network to operate properly. Having the UE-identifying information omitted or removed from the reporting transmissions may be preferrable in some instances, such as when privacy of a user of a UE is desired. Approaches described herein may provide for UE-identifying information being omitted and/or removed from reporting transmissions for privacy of users of the network.

For a first approach and a second approach, the core concept is a service that allows UE to send small amount of data anonymously. For example, the first approach and the second approach may allow UEs to transmit uplink data transmissions that are anonymous to a core network of network serving the UEs. This is especially useful for data containing sensitive information.

A first approach may define the service for small anonymized uplink (UL) traffic with shared N3 tunnel between a base station (such as a gNB or a next generation radio access network (RAN) Node) and a user plane function (UPF) (or a next generation User Plane function). For example, the first approach may include have a shared N3 tunnel being established between a base station and a UPF of the network. The shared N3 tunnel may be utilized for transmission of anonymized UL data transmissions from the base station to the UPF. The shared N3 tunnel may be available to two or more UEs for transmission of anonymized data transmissions, as described further throughout this disclosure.

A second approach extends the first approach with a shared UL channel between UEs and a base station (such as a gNB) to send the anonymous traffic to base station. For example, the second approach may have a shared UL channel that is established with a base station. One or more UEs may utilize the shared UL channel to transmit anonymized UL data transmissions to the base station.

For a third approach, the core concept is a method to use user plane transport layer security to report privacy sensitive data to secure servers (network functions) in the network. UE is configured with necessary user plane parameters (for example, protocol data unit (PDU) session parameters) to send sensitive UE information like measurement report including UE location to the network function requesting such information. Assumption: the network function requesting such information is a trusted entity and will not seek to map UE's internet protocol (IP) address information to the UE Identities held by the NFs like unified data management (UDM)/access and mobility management function (AMF)/session management function (SMF).

### First Approach

In the first approach, a service may be used for sending small amounts of anonymized data from UE to the network (for example, user data plane (UDP)). A base station (such as a gNB) of the network is a trusted entity (it does not have the permanent identifier of the UE). For example, the base station may store temporary identifiers for UEs connected to the base station, without storing permanent identifiers of the UEs.

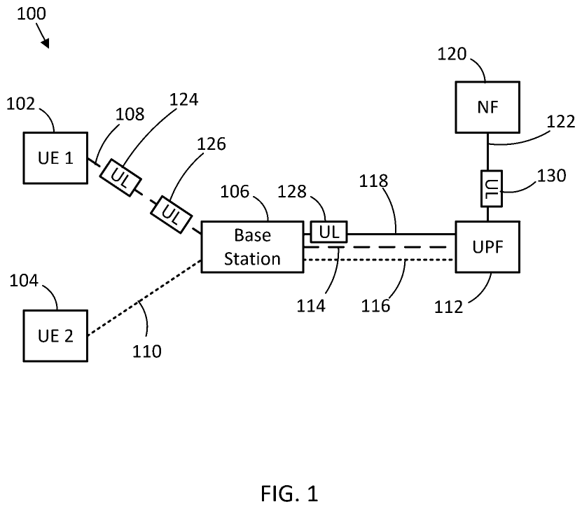

FIG. 1 illustrates an example network arrangement 100 in accordance with some embodiments. For the example, the network arrangement 100 illustrates an example of a portion of a network that implements the first approach. The network arrangement 100 may allow UEs within the network arrangement 100 to transmit anonymized UL data to a network function of the network arrangement 100.

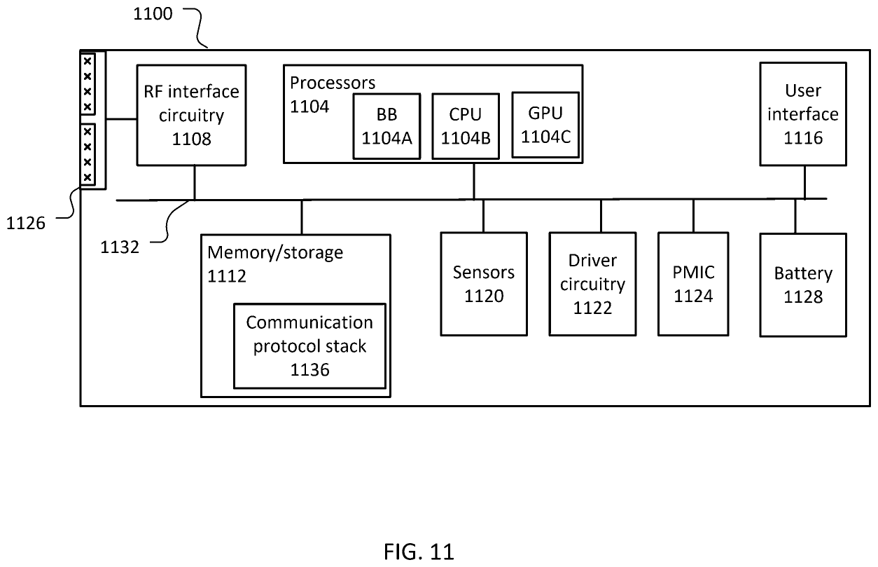

The network arrangement 100 may include a first UE 102 and a second UE 104. Each of the first UE 102 and the second UE 104 may include one or more of the features of the UE 1100 (FIG. 11). Each of the first UE 102 and the second UE 104 may generate UL data transmissions that can be provided to a network. Further, each of the first UE 102 and the second UE 104 may perform measurements (such as quality of service measurements, amplitude measurements, and/or other measurements known by one skilled in the art to be performed by UEs) and generate data based on the measurements. The data from the measurements may be formatted into a report and one or more UL data transmissions may be generated with the report, or parts thereof. Each of the first UE 102 and the second UE 104 may be capable of establishing connections with base stations of the network through which the first UE 102 and the second UE 104 may communicate with the network.

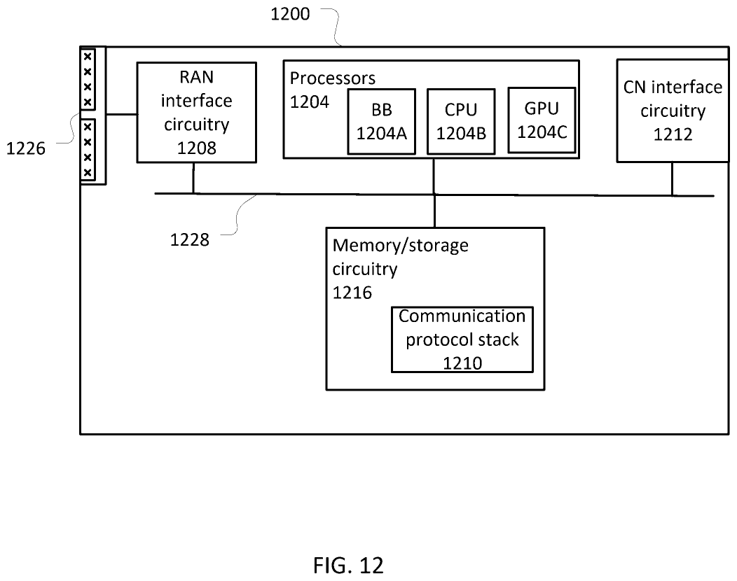

The network arrangement 100 may include a base station 106. The base station 106 may include one or more of the features of the gNB 1200 (FIG. 12). The base station 106 may be part of an access network of a network that can provide services to UEs.

The first UE 102 and the second UE 104 may establish connections with the base station 106. For example, the first UE 102 may establish a first connection 108 with the base station 106 and the second UE 104 may establish a second connection 110 with the base station 106. The first connection 108 may extend between the first UE 102 and the base station 106. The first UE 102 may utilize the first connection 108 to exchange transmissions (including UL traffic from the first UE 102) with the base station 106. The second connection 110 may extend between the second UE 104 and the base station 106. The second UE 104 may utilize the second connection 110 to exchange transmissions (including UL traffic from the second UE 104) with the base station 106.

The network arrangement 100 may include a UPF 112. The UPF 112 may be a network function of a core network of the network. The UPF 112 may comprise one or more hardware elements and/or software of the core network. The UPF 112 may be responsible for routing and forwarding user plane packets between the base station 106 and an external data network.

The UPF 112 may have a tunnel to the base station 106. For example, the UPF 112 may have a first tunnel 114, a second tunnel 116, and a third tunnel 118 between the UPF 112 and the base station 106. The first tunnel 114 may correspond to the first UE 102 and may be utilized for exchanging communications between the base station 106 and the UPF 112 related to the first UE 102. The second tunnel 116 may correspond to the second UE 104 and may be utilized for exchanging communications between the base station 106 and the UPF 112 related to the second UE 104.

The third tunnel 118 may comprise a shared channel that is available for two or more UEs. In particular, the base station 106 may utilize the third tunnel 118 to provide transmissions from two or more UEs to the UPF 112. For example, the base station 106 may utilize the third tunnel 118 to provide transmissions from the first UE 102 and/or the second UE 104 to the UPF 112 in the illustrated embodiment. The base station 106 may be able to identify portions of the transmissions from the first UE 102 and/or portions of the transmissions from the second UE 104 to be transmitted to the UPF 112 via the third tunnel 118, as described further throughout this disclosure. Further, the transmissions provided from the base station 106 to the UPF 112 via the third tunnel 118 may have UE-identifying information omitted, as described further throughout this disclosure.

The network arrangement 100 may include a network function (NF) 120. The NF 120 may be a network function of a core network of the network. The NF 120 may be configured to receive reports from UEs within the network arrangement 100, such as the first UE 102 and/or the second UE 104. The NF 120 may be coupled to the UPF 112 via an interface 122. The interface 122 may provide for exchange of IP packets between the NF 120 and the UPF 112 using an IP 5-tuple to identify a transmission control protocol (TCP/IP) connection. The interface 122 may correspond to the third tunnel 118 and the UPF 112 may provide transmissions received via the third tunnel 118 to the NF 120 via the interface 122.

A service provided by the network arrangement 100 can be utilized for any UL traffic that is to be anonymized. The network arrangement 100 shows an example of an NF (acting as a server) using the service for getting anonymized reports from the UEs including their location. For example, the NF 120 may act as a server in the illustrated embodiment. The NF 120 may obtain anonymized reports from one or more UEs in the network arrangement 100, such as the first UE 102 and the second UE 104.

The UEs within the network arrangement 100 may be provisioned with reporting parameters. For example, the first UE 102 and the second UE 104 may be provisioned with reporting parameters for providing reports to the network, such as providing reports to the NF 120. The reporting parameters may include PDU session information, a fully qualified domain name (FQDN) and/or an IP address of the NF 120, a configuration for reporting (such periodicity and/or trigger condition), or some combination thereof. The reporting parameters may be provided to the UEs as part of a shared channel configuration for the third tunnel 118 (which is the shared channel) maintained by the base station 106. The base station 106 may configure the first UE 102 and the second UE 104 with the shared channel configuration via a UE route selection policy (URSP) or control plane signaling.

The first UE 102 may establish the first connection 108 with the base station 106 using the received shared channel configuration. The first connection 108 may provide a PDU session for the first UE 102 in accordance with the shared channel configuration. The first connection 108 may provide data radio bearers (DRBs) and/or an N3 tunnel, or portion thereof, to the first UE 102.

The second UE 104 may establish the second connection 110 with the base station 106 using the received shared channel configuration. The second connection 110 may provide a PDU session for the second UE 104 in accordance with the shared channel configuration. The second connection 110 may provide DRBs and/or an N3 tunnel, or portion thereof, to the second UE 104.

The first UE 102 may transmit UL transmissions to the base station 106 via the first connection 108 and the second UE 104 may transmit UL transmissions to the base station 106 via the second connection 110. The transmissions transmitted by the first UE 102 and/or the second UE 104 to the base station 106 may comprise anonymized UL transmissions and/or regular UL transmissions. The shared channel configuration may define the transmission of the anonymized UL transmissions and/or the regular UL transmissions. For example, the shared channel configuration may define PDU sessions that are to be utilized for the anonymized UL transmissions, DRBs that are to be utilized for the anonymized UL transmissions, and/or information to be included in the anonymized UL transmissions. The base station 106 may determine whether transmissions from the first UE 102 and/or the second UE 104 are anonymized UL transmissions or regular UL transmissions based on characteristics associated with the transmissions, such as the PDU session that includes the transmission, the DRB carrying the transmission, and/or information within the transmission. The base station 106 may process each of the transmissions according to whether the transmissions are determined to be anonymized UL transmissions or regular UL transmissions.

In instances where the base station 106 determines that transmissions received from the first UE 102 and the second UE 104 are regular UL transmissions, the base station 106 may provide the regular UL transmissions to the UPF 112 for processing. In particular, the base station 106 may utilize the first tunnel 114 to provide the regular UL transmissions received from the first UE 102 to the UPF 112 for processing. The base station 106 may utilize the second tunnel 116 to provide the regular UL transmissions received from the second UE 104 to the UPF 112 for processing.

In instances where the base station 106 determines that transmissions received from the first UE 102 and the second UE 104 are anonymized UL transmissions, the base station 106 may provide the anonymized UL transmissions to the NF 120. The base station 106 may provide the anonymized UL transmissions to the NF 120 via the third tunnel 118.

The third tunnel 118 may comprise an N3 tunnel, or a portion thereof. The anonymized UL transmissions may proceed via the interface 122 to the NF 120. The interface 122, may further comprise the N3 tunnel, or a portion thereof.

In some embodiments, the UEs providing the anonymized UL transmissions may leave a source IP address field of the anonymized UL transmissions blank or may assign a randomized IP address to the source IP address field of the anonymized UL transmissions. For example, the first UE 102 may leave a source IP address field of any of the anonymized UL transmissions transmitted by the first UE 102 blank or may assign a randomized IP address to the source IP address field of any of the anonymized UL transmissions transmitted by the first UE 102. Further, the second UE 104 may leave a source IP address field of any of the anonymized UL transmissions transmitted by the second UE 104 blank or may assign a randomized IP address to the source IP address field of any of the anonymized UL transmissions transmitted by the second UE 104. In these embodiments, the processing of the anonymized UL transmissions received from the first UE 102 and/or the second UE 104 may comprise the base station 106 providing the anonymized UL transmissions to the NF 120 via the N3 tunnel through the third tunnel 118 and the interface 122.

In some embodiments, the base station 106 may remove any UE-identifying information from the anonymized UL transmissions received from the UEs. For example, the anonymized UL transmissions may include a source IP address corresponding to the UE that transmits the anonymized UL transmissions in some embodiments. In particular, the first UE 102 may transmit any anonymized UL transmissions with a source IP address for the first UE 102 in the source IP address field of the anonymized UL transmissions. Further, the second UE 104 may transmit any anonymized UL transmissions with a source IP address for the second UE 104 in the source IP address field of the anonymized UL transmissions. The base station 106 may remove the source IP addresses from the source IP address fields of any of the anonymized UL transmissions received by the base station 106 as part of the processing of the anonymized UL transmissions. Further, the base station 106 may replace the source IP addresses within the source IP address fields of the received anonymized UL transmissions with an IP address of the base station 106. The base station 106 may then provide the anonymized UL transmissions to the NF 120 via the N3 tunnel through the third tunnel 118 and the interface 122.

As an example, the first UE 102 may be triggered to generate a measurement report in some instances. The first UE 102 may perform a measurement and a generate a report based on the results of the measurement. The first UE 102 may generate one or more UL data transmissions that include the report or portions thereof. The first UE 102 may determine that the one or more UL data transmissions are to be anonymized for the report. In some embodiments, the first UE 102 may leave a source IP address field in the one or more anonymized UL data transmissions blank or may assign a randomized IP address to the source IP address field in the one or more anonymized UL data transmissions. In other embodiments, the first UE 102 may assign a source IP address corresponding to the first UE 102 to the source IP address field in the one or more anonymized UL data transmissions.

The first UE 102 may transmit the anonymized UL data transmissions to the base station 106 in accordance with the shared channel configuration. For example, the first UE 102 may transmit the anonymized UL data transmissions within certain PDU sessions, on certain DRBs, and/or with certain information that indicate the anonymized UL data transmissions are to be processed as anonymized UL data transmissions in accordance with the shared channel configuration. As an example, a first anonymized UL data transmission 124 and a second anonymized UL data transmission 126 are shown transmitted by the first UE 102 on the first connection 108 to the base station 106.

The base station 106 may receive the anonymized UL data transmissions from the first UE 102. In some embodiments, the base station 106 may remove the UE-identifying information from the anonymized UL data transmissions and/or assign an IP address of the base station 106 to the source IP address fields of the anonymized UL data transmissions. The base station 106 may then provide the anonymized UL data transmissions on the third tunnel 118 to the UPF 112. For example, a third anonymized UL data transmission 128 is shown transmitted by the base station 106 on the third tunnel 118 to the UPF 112.

The UPF 112 may receive the anonymized UL data transmissions from the base station 106. The UPF 112 may be unable to determine a source of the anonymized UL data transmissions based on the UE-identifying information being omitted from the anonymized UL data transmissions. The UPF 112 may provide the anonymized UL data transmissions on the interface 122 to the NF 120. For example, a fourth anonymized UL data transmission 130 is shown transmitted by the UPF 112 to the NF 120.

The NF 120 may receive the anonymized UL data transmissions from the UPF 112. The NF 120 may process the anonymized UL data transmissions received. However, the NF 120 may be unable to determine the source of the anonymized UL data transmissions based on the UE-identifying information being omitted from the anonymized UL data transmissions. The NF 120 may utilize the data received in the anonymized UL data transmissions for operations of the network.

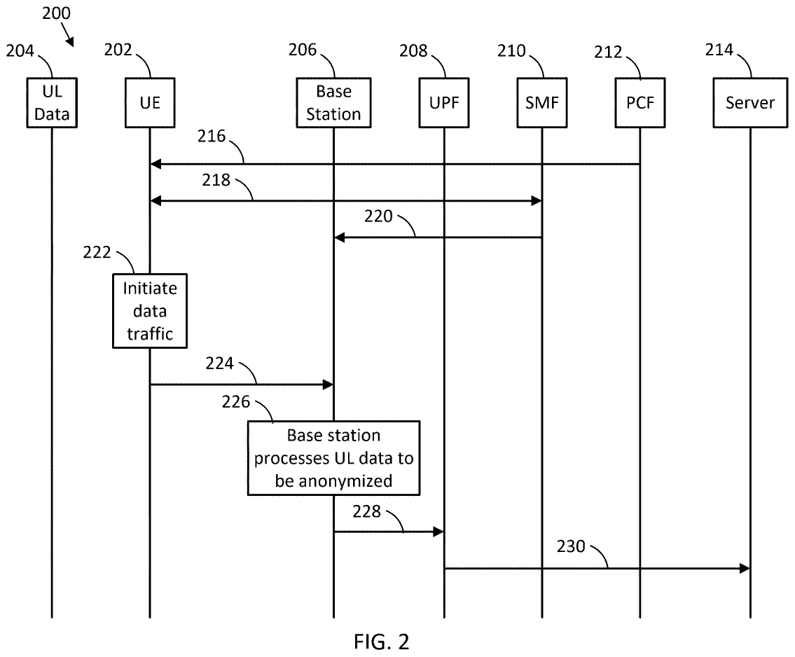

FIG. 2 illustrates an example call flow 200 for a service for sending anonymized UL data in accordance with some embodiments. For example, the call flow 200 illustrates example entities and signals that may implement the first approach in accordance with some embodiments, as described in relation to FIG. 1.

The call flow 200 may include a UE 202. The UE 202 may include one or more of the features of the first UE 102 (FIG. 1), the second UE 104 (FIG. 1), and/or the UE 1100 (FIG. 11). The call flow 200 may further include UL data 204. The UL data 204 may be maintained by the UE 202. For example, a memory of the UE 202 may store the UL data 204. The UE 202 may generate the UL data 204 and/or transmit the UL data 204 to a network during operation. The UL data 204 may include UL data to be included in an anonymized UL data transmission to be transmitted to the network.

The call flow 200 may include a base station 206. The base station 206 may include one or more of the features of the base station 106 (FIG. 1) and/or the gNB 1200 (FIG. 12). In some embodiments, the base station 206 may comprise a gNB. The base station 206 may provide service to the UE 202, such that the UE 202 may communicate with a network that includes the base station 206 via the base station 206. The base station 206 may be part of an access network of the network, where the access network can provide access to the network for UEs (such as the UE 202).

The call flow 200 may include a UPF 208. The UPF 208 may include one or more of the features of the UPF 112 (FIG. 1). The UPF 208 may be connected to the base station 206 and may communicate with the base station 206.

The call flow 200 may include a session management function (SMF) 210. The SMF 210 may perform PDU session management, IP address allocation, general packet radio service tunnelling protocol user (GTP-U) tunnel management, and/or downlink notification management. The SMF 210 may provide the services for the base station 206 and/or UEs connected to the base station 206.

The call flow 200 may include a policy control function (PCF) 212. The PCF 212 may provide policies associated with mobility management and policies associated with session management. The PCF 212 may provide the services for the base station 206 and/or UEs connected to the base station 206.

The call flow 200 may include a server 214. The server 214 may be a network server that operates the network. The UPF 208, the SMF 210, the PCF 212, and/or the server 214 may be part of a core network of the network.

The PCF 212 may provision the UE 202 with policies for sending anonymized UL data. For example, the PCF 212 may transmit one or more transmissions 216 to the UE 202 to provision the UE 202 with policies for transmitting anonymized UL data transmissions. The PCF 212 may provide the transmissions 216 to the UE 202 via the base station 206. The transmissions 216 provided by the PCF 212 may be transparently carried over the base station 206 in a UE policy container generated by the PCF 212. The transmissions 216 provided via the base station 206 may cause the UE 202 to be configured for anonymized UL data transmissions.

The transmissions 216 may include information for reporting (PDU Session information through URSP) in some embodiments. Alternatively, this information may be provided over control plane signaling and through the base station 206, (for example, Measurement and Reporting Configuration). Alternatively, this information can be pre-provisioned using “non-third generation partnership project (3GPP) methods” (for example, the way access point name (APN) information is provisioned in legacy approaches). This information may be provisioned either based on UE's capability to support sending anonymized UL traffic and/or based on UE's subscription information that allows UE to send anonymized UL traffic.

The UE 202 may establish a PDU session. For example, the UE 202 may exchange one or more transmissions 218 with the SMF 210 to establish a PDU session with the network. This could be a dedicated PDU session used exclusively for sending anonymized UL traffic. For example, the PDU session established by the UE 202 may be used for transmitting anonymized UL data transmissions from the UE 202 to the network.

The base station 206 may be provisioned with information. For example, the SMF 210 may provide one or more transmissions 220 to the base station 206 to provide the information to the base station 206 for facilitating the anonymized UL data transmissions. The transmissions 220 do not necessarily happen after the transmissions 218. Furthermore, the transmissions 220 may be likely to happen immediately after N2/NG interface establishment. The information may include information to setup a shared tunnel to the UPF 208 (e.g., N3 tunnel). Further, the information may include information to map UL traffic of interest of the UE 202 to the shared N3 tunnel to a UPF (such as the UPF 208). The information may further include information to setup the DRB for the UE 202 to send the traffic to be anonymized. The DRB may be part of a dedicated PDU session or part of an existing PDU Session. This DRB may not have its own N3 tunnel in the Core Network. This DRB may have different quality of service (QOS) rules, such as low priority and/or longer packet delay budgets (PDBs). Alternatively, this information may be sent to the base station 206 as a radio resource control (RRC) message over a Signaling Radio Bearer.

The UE 202 may initiate data traffic in 222. The UE 202 may send the UL traffic that has to be anonymized. For example, the UE 202 may transmit one or more anonymized UL data transmissions 224 to the base station 206. The UE 202 may optionally leave the source IP address blank within the anonymized UL data transmissions 224 in some embodiments. In some embodiments, the UE 202 may optionally assign a randomized IP address to source IP address field within the anonymized UL data transmissions 224.

The base station 206 may process these packet data convergence protocol (PDCP) PDUs to be sent on the shared N3 tunnel. For example, the base station 206 may process the anonymized UL data transmissions 224 received from the UE 202. Optionally, if the packets contain source IP address, the base station 206 removes it or replaces UE IP address with its own IP address as the source address in 226. For example, the anonymized UL data transmissions 224 may have IP addresses corresponding to the UEs that generated the anonymized UL data transmissions 224 assigned to the source IP address field of the anonymized UL data transmissions 224. The base station 206 may remove the IP addresses corresponding to the UEs from the source IP address field and/or replace the IP addresses with an IP address that corresponds to the base station 206. The base station 206 may send the PDUs on shared N3 tunnel. For example, the base station 206 may provide the anonymized UL data transmissions 224 to the UPF 208 and/or to an NF (such as the NF 120 (FIG. 1)) in transmissions 228 via a shared N3 tunnel, such as the shared N3 tunnel that can extend through the third tunnel 118 (FIG. 1) and/or the interface 122 (FIG. 1).

The UPF 208 may receive the transmissions 228, including the anonymized UL data transmissions 224, from the base station 206. The UPF 208 may fill in its own IP address as the source IP address while sending the packets to the server. For example, the UPF 208 may assign an IP address corresponding to the UPF 208 to the source IP address field within the anonymized UL data transmissions 224 in some embodiments. The UPF 208 may transmit one or more transmissions 230, including the anonymized UL data transmission 224, to the server 214. The one or more transmissions 230 may be provided to the server 214 via the shared N3 tunnel, such as the shared N3 tunnel formed via the third tunnel 118 and/or the interface 122. This service may be for unidirectional UDP type of traffic.

### Second Approach

In the second approach, a service may be used for small anonymized data transmission, such as via shared UL. The second approach may be for the Uu interface between a UE and a base station. Between the base station, the UPF and the server, the principles described in the first approach may be used. For example, the first approach of having a shared N3 channel between the base station, the UPF and the server may be implemented with the second approach for the Uu interface between the UE and the base station in some embodiments.

In this approach, there may be no dedicated DRB configured per UE for sending anonymized UL data. Instead, all UEs may use a common cell radio network temporary identifier (C-RNTI) for sending anonymized UL data in some embodiments.

Alternatively, the random access network (RAN) may assign a second UE-identifier (ID) of the same type to all these UEs to be used for sending anonymized UL data in some embodiments. In order for this to work, the UE and RAN may have to inform each other of the capability during the handshake of establishing Radio Resources. Alternatively, in some embodiments, every UE can be allocated with 2 or more C-RNTIs (this can also be applied without shared tunnel), the base station may only store one permanent C-RNTI for normal transmission. For some two C-RNTI approaches, a unique C-RNTI may be for normal data, and the shared C-RNTI may be for sensitive data. For some approaches with more than 2 C-RNTIs, one C-RNTI may be permanent for normal data, and other C-RNTIs are dynamic for sensitive data.

In order to make sure that other (unauthorized) UEs cannot use this shared channel, the RAN may assign a common “mask” to the authorized UEs to be used when sending the UL data for protection. The UE may scramble the common C-RNTI and/or the C-RNTI for sensitive data by means of a mask/code that was allocated/assigned by the network. Using this approach, while the ID of the UE is not revealed, the RAN can make sure that the data is being sent by the correct/authorized UEs. The mask could also be the public key of asymmetric crypto for the protection, for example, elliptic curve-based certificateless signatures for identity-based encryption (ECCSI), RSA, or may be future Post Quantum Cryptography. The mask could also be the key of symmetric crypto for the protection, for example, advanced encryption standard (AES). For tighter protection, the RAN can/will change the “mask” based on local policies. Contention resolution principle is for further study, a UE may use a hash of its short temporary mobile subscriber identity (S-TMSI).

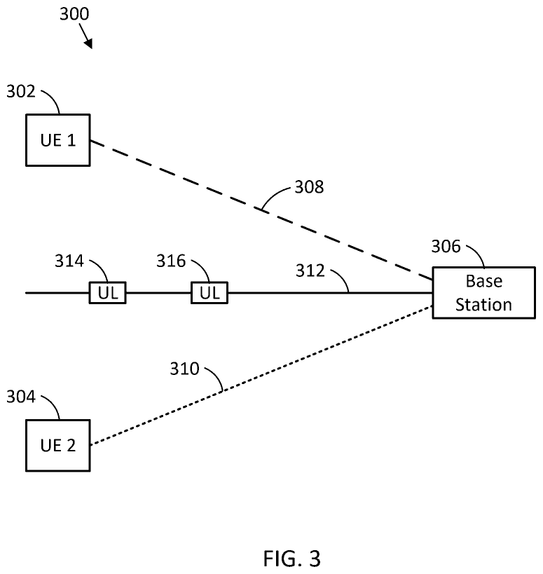

FIG. 3 illustrates an example network arrangement 300 in accordance with some embodiments. For example, the network arrangement 300 illustrates an example of a portion of a network that implements the second approach. The network arrangement 300 may allow UEs within the network arrangement 300 to transmit anonymized UL data to an NF of the network arrangement 300.

The network arrangement 300 may include a first UE 302 and a second UE 304. Each of the first UE 302 and the second UE 304 may include one or more of the features of the first UE 102 (FIG. 1), the second UE 104 (FIG. 1), the UE 202 (FIG. 2), and/or the UE 1100 (FIG. 11). Each of the first UE 302 and the second UE 304 may generate UL data transmissions that can be provided to a network. Further, each of the first UE 302 and the second UE 304 may perform measurements (such as quality of service (QOS) measurements, quality of experience (QoE) measurements, amplitude measurements, and/or other measurements known by one skilled in the art to be performed by UEs) and generate data based on the measurements. The data from the measurements may be formatted into a report and one or more UL data transmissions may be generated with the report, or parts thereof. Each of the first UE 302 and the second UE 304 may be capable of establishing connections with base stations of the network through which the first UE 302 and the second UE 304 may communicate with the network.

The network arrangement 300 may include a base station 306. The base station 306 may include one or more of the features of the base station 106 (FIG. 1), the base station 206 (FIG. 2), and/or the gNB 1200 (FIG. 12). The base station 306 may be part of an access network of a network that can provide services to UEs.

The first UE 302 and the second UE 304 may establish connections with the base station 306. For example, the first UE 302 may establish a first connection 308 with the base station 306 and the second UE 304 may establish a second connection 310 with the base station 306. The first connection 308 may extend between the first UE 302 and the base station 306. The first UE 302 may utilize the first connection 308 to exchange transmissions (including UL traffic from the first UE 302) with the base station 306. The second connection 310 may extend between the second UE 304 and the base station 306. The second UE 304 may utilize the second connection 310 to exchange transmissions (including UL traffic from the second UE 304) with the base station 306.

The network arrangement 300 may include a shared UL channel 312. The shared UL channel 312 can be used by UEs for sending anonymized UL traffic. For example, the first UE 302 and/or the second UE 304 may utilize the shared channel for transmitting anonymized UL data transmissions to the base station 306. A service provided by the network arrangement 100 can be utilized for any UL traffic that is to be anonymized.

The UEs within the network arrangement 300 may be provisioned with reporting parameters. For example, the first UE 302 and the second UE 304 may be provisioned with reporting parameters for providing reports to the network. The reporting parameters may include PDU session information, an FQDN and/or an IP address of a NF, a measurement configuration, or some combination thereof. The reporting parameters may be provided to the UEs as part of a shared channel configuration maintained by the base station 306. The shared channel configuration may include, a common C-RNTI for the shared UL channel 312, a UE-ID for the shared UL channel 312 (along with a UE-ID corresponding to the UE in some embodiments, a C-RNTI for the shared UL channel 312 for the UE and a C-RNTI for normal transmissions of the UE, a permanent C-RNTI for normal transmissions of the UE and one or more other C-RNTIs for the shared UL channel 312, or some combination thereof. In some embodiments, the shared channel configuration may further include a mask and/or code (which is collectively referred to as “mask” herein) for scrambling the ID corresponding to the shared UL channel 312 (for example, the UE-ID corresponding to the shared UL channel 312 and/or the C-RNTI corresponding to the shared UL channel 312). The mask may comprise a public key of asymmetric cryptography (such as an ECCSI value, an RSA value, and/or a post quantum cryptographic value) or a key of symmetric cryptography (such an AES value). In some embodiments, the value of the mask may be based on local policies.

The first UE 302 and the second UE 304 may utilize the shared UL channel 312 for transmitting anonymized UL data transmissions to the base station 306 using the received shared channel configuration. For example, the first UE 302 and the second UE 304 may utilize the C-RNTI and/or the UE-ID from the shared channel configuration for the anonymized UL data transmissions to transmit the anonymized UL data transmissions on the shared UL channel 312.

In the illustrated embodiment, a first anonymized UL data transmission 314 and a second anonymized UL data transmission 316 are shown being transmitted on the shared UL channel 312 to the base station 306. The first anonymized UL data transmission 314 and the second anonymized UL data transmission 316 may have been transmitted by the first UE 302, the second UE 304, or some combination thereof. The first anonymized UL data transmission 314 and the second anonymized UL data transmission 316 may have been transmitted using the C-RNTI and/or the UE-ID corresponding to the shared UL channel 312. In some embodiments, UE-identifying information may be omitted from the first anonymized UL data transmission 314 and the second anonymized UL data transmission 316 and/or the first anonymized UL data transmission 314 and the second anonymized UL data transmission 316 may include temporary identifiers such that base station 306 may be unable to identify the particular UE.

The base station 306 may receive the first anonymized UL data transmission 314 and the second anonymized UL data transmission 316 transmitted on the shared UL channel 312. The base station 306 may provide the first anonymized UL data transmission 314 and the second anonymized UL data transmission 316 to a corresponding NF. In some embodiments, the base station 306 may provide the first anonymized UL data transmission 314 and the second anonymized UL data transmission 316 to the corresponding NF via a shared N3 channel, such as the shared N3 channel described in relation to the network arrangement 100 (FIG. 1) and/or the call flow 200 (FIG. 2). The NF may receive the first anonymized UL data transmission 314 and the second anonymized UL data transmission 316 and utilize the data from the anonymized UL data transmissions for operation of the network.

### Third Approach

The third approach may implement secure transport of UE information over the user plane. A UE may be provisioned with the FQDN/IP address of the network function that requests UE information (for example, a self-organizing network (SON) Server). Such an NF address may be routable by the UPF in the core network. NF could be inside or outside the network address translation (NAT) domain for the network. UE may use a secure connection that uses transport layer security (TLS) to the NF. The NF will not map the client address to a UE ID in the network.

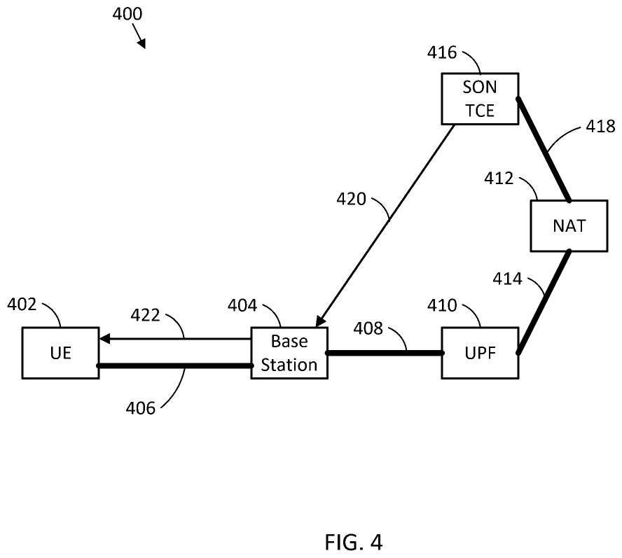

FIG. 4 illustrates an example network arrangement 400 in accordance with some embodiments. For example, the network arrangement 400 illustrates an example of a portion of network that implements the third approach. The network arrangement 400 may allows UEs within the network arrangement 400 to securely transmit UE information over the user plane of the network utilizing secure transports.

The network arrangement 400 may include a UE 402. The UE 402 may include one or more of the features of the first UE 102 (FIG. 1), the second UE 104 (FIG. 1), the UE 202 (FIG. 2), the first UE 302 (FIG. 3), the second UE 304 (FIG. 3), and/or the UE 1100 (FIG. 11). The UE 402 may generate UL data transmissions that can be provided to a network. Further, the UE 402 may perform measurements (such as quality of service measurements, amplitude measurements, and/or other measurements known by one skilled in the art to be performed by UEs) and generate data based on the measurements. The data from the measurements may be formatted into a report and one or more UL data transmissions may be generated with the report, or parts thereof. The UE 402 may be capable of establishing connections with base stations of the network through which the UE 402 may communicate with the network.

The network arrangement 400 may include a base station 404. The base station 404 may include one or more of the features of the base station 106 (FIG. 1), the base station 206 (FIG. 2), the base station 306 (FIG. 3), and/or the gNB 1200 (FIG. 12). The base station 404 may be part of an access network of a network that can provide services to UEs.

The UE 402 may establish one or more connections with the base station 404. For example, the UE 402 may establish a first connection 406 with the base station 404. The first connection 406 may extend between the UE 402 and the base station 404. The UE 402 may utilize the first connection 406 to exchange transmissions (including UL traffic from the UE 402) with the base station 404.

The network arrangement 400 may include a UPF 410. The UPF 410 may include one or more of the features of the UPF 112 (FIG. 1) and/or the UPF 208 (FIG. 2). The UPF 410 may be a network function of a core network of the network. The UPF 410 may comprise one or more hardware elements and/or software of the core network. The UPF 410 may be responsible for routing and forwarding user plane packets between the base station 404 and an external data network.

The UPF 410 may be connected to the base station 404. For example, the UPF 410 may be connected to the base station 404 by a second connection 408. The second connection 408 may be utilized for exchanging communications between the base station 404 and the UPF 410.

The network arrangement 400 may include a NAT 412. The NAT 412 may be a network function of the core network. Foor example, the NAT 412 may comprise one or more hardware elements and/or software of the core network. The NAT 412 may translate internal private network addresses into public network IP addresses, and vice versa.

The NAT 412 may be connected to the UPF 410. For example, the NAT 412 may be connected to the UPF 410 by a third connection 414. The third connection 414 may be utilized for exchanging communications between the UPF 410 and the NAT 412. In some embodiments, the NAT 412 may be omitted.

The network arrangement 400 may include a SON server 416. In some embodiments, the SON server 416 may include a trace collection entity (TCE). For example, the SON server 416 may collect trace information related to the network.

In embodiments that include the NAT 412, the SON server 416 may be connected to the NAT 412. For example, the SON server 416 may be connected to the NAT 412 by a fourth connection 418. The fourth connection 418 may be utilized for exchanging communications between the NAT 412 and the SON server 416. In some embodiments, the fourth connection 418 may comprise an N6 interface. In some of these embodiments, the SON server 416 may be located outside of the NAT domain of the network.

In embodiments where the NAT 412 is omitted, the SON server 416 may be connected to the UPF 410. For example, the SON server 416 may be connected to the UPF 410 by a fifth connection. The fifth connection may be utilized for exchanging communications between the UPF 410 and the SON server 416. In some of these embodiments, the SON server 416 may be located inside of the NAT domain of the network. Further, there may still be a NAT within the network in some of these embodiments, although the NAT is not connected between the UPF 410 and the SON server 416.

As an example, the network arrangement 400 may implement SON measurement reporting. The SON server 416 may provide a measurement configuration 420 to the base station 404. The base station 404 may receive the measurement configuration 420 and utilize the measurement configuration 420 in configuring the UE 402.

The base station 404 may provide SON reporting parameters 422 to the UE 402. In some embodiments, the base station 404 may provide the SON reporting parameters 422 via RRC signaling to the UE 402. The SON reporting parameters may include PDU session information, a FQDN or IP address corresponding to the SON server 416, the measurement configuration 420, or some combination thereof. The SON reporting parameters 422 provided by the base station 404 may configure the UE 402 for establishing a secure connection to the SON server 416 that uses TLS.

The UE 402 may be triggered to perform a measurement and generate measurement results. The UE 402 may send the measurement results, location over the PDU session indicated in the SON reporting parameters. For example, the UE 402 may generate a UL data transmission that includes the measurement results and/or a location of the UE 402. The UE 402 may transmit the UL data transmission over the PDU session indicated in the SON reporting parameters. The UL data transmission transmitted by the UE may be protected by TLS.

The UE 402 may establish a secure connection with the SON server 416 over which the UL data transmission is to be transmitted. In some embodiments, the secure connection may implement layer 4 security. The secure connection may extend through the first connection 406, the base station 404, the second connection 408, the UPF 410, the third connection 414, the NAT 412, and/or the fourth connection 418 to the SON server 416. Due to the TLS, the entities between the UE 402 and the SON server 416 are unable to access and/or process the data with the UL data transmission. In particular, the base station 404, the UPF 410, and/or the NAT 412 may be prevented from accessing and/or processing the data within the UL data transmission transmitted from the UE 402 to the SON server 416.

The SON server 416 may receive the UL data transmission via the secure connection. The SON server 416 may process the data included in the UL data transmission for operation of the network.

In a first alternative of the third approach, the network may configure a URSP rule for sending SON measurement results (originate from PCF). A route selection descriptor (RSD) may include the PDU session over which measurement results are to be sent. UE RRC may provide the measurement results to upper layers (for example, Measurement (Meas) client), which may take care of sending the results to the SON server (acting as the TCE).

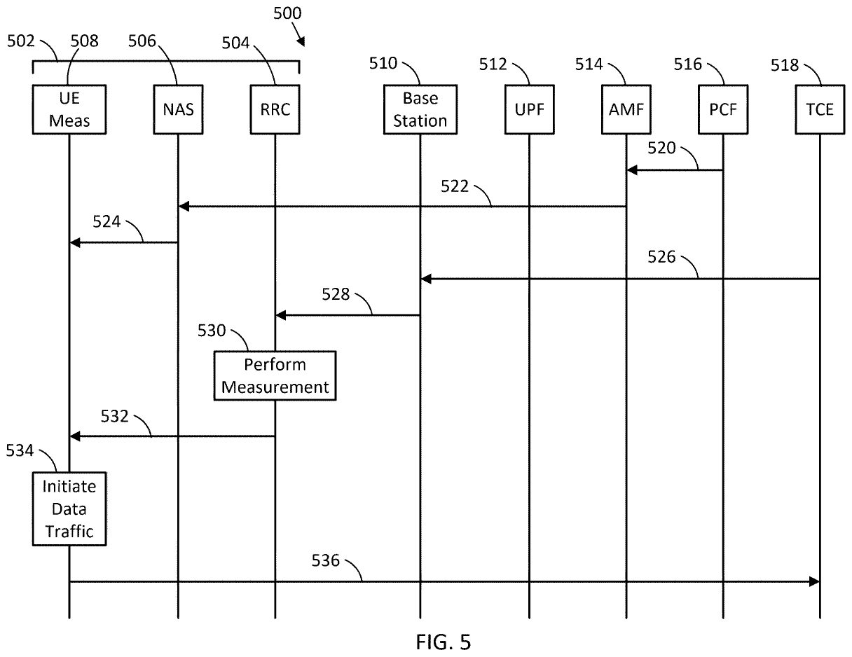

FIG. 5 illustrates an example signaling chart 500 for the first alternative of the third approach using URSP rules in accordance with some embodiments. For example, the signaling chart 500 illustrates example entities and signals that may implement the first alternative of the third approach in accordance with some embodiments.

The signaling chart 500 may include a UE 502. The UE 502 may include one or more of the features of the first UE 102 (FIG. 1), the second UE 104 (FIG. 1), the UE 202 (FIG. 2), the first UE 302 (FIG. 3), the second UE 304 (FIG. 3), the UE 402 (FIG. 4), and/or the UE 1100 (FIG. 11). The signaling chart 500 illustrates portions of the UE 502. In particular, the signaling chart 500 illustrates an RRC entity 504 of the UE 502, a non-access stratum (NAS) entity 506 of the UE 502, and a UE measurement client 508 of the UE 502.

The signaling chart 500 may include a base station 510. The base station 510 may include one or more of the features of the base station 106 (FIG. 1), the base station 206 (FIG. 2), the base station 306 (FIG. 3), the base station 404 (FIG. 4), and/or the gNB 1200 (FIG. 12). In some embodiments, the base station 510 may comprise a gNB. The base station 510 may provide service to the UE 502, such that the UE 502 may communicate with a network that includes the base station 510 via the base station 510. The base station 510 may be part of an access network of the network, where the access network can provide access to the network for UEs (such as the UE 502).

The signaling chart 500 may include a UPF 512. The UPF 512 may include one or more of the features of the UPF 112 (FIG. 1), the UPF 208 (FIG. 2), and/or the UPF 410 (FIG. 4).

The signaling chart 500 may include an AMF 514. The AMF 514 may perform registration management, reachability management, connection management, and/or mobility management for the network.

The signaling chart 500 may include a PCF 516. The PCF 516 may include one or more of the features of the PCF 212 (FIG. 2). The PCF 516 may provide policies associated with mobility management and policies associated with session management.

The signaling chart may include a TCE 518. The TCE 518 may include one or more of the features of the SON server 416 (FIG. 4). The TCE 518 may collect trace information related to the network. The UPF 512, the AMF 514, the PCF 516, and/or the TCE 518 may be part of a core network of the network.

The PCF 516 may provide a UE policy container 520 to the AMF 514. The UE policy container 520 may include URSP rules for measurement reporting traffic. The URSP rules may include FQDN and/or PDU session parameters. The URSP rules may provide the UE with a configuration for sending SON measurement results. The URSP rules may include an RSD that may indicate a PDU session over which measurement results are to be sent from the UE 502 to the TCE 518.

The AMF 514 may receive the UE policy container 520 from the PCF 516. The AMF 514 may provide a configuration update command 522 to the NAS entity 506. The configuration update command 522 may include the data from the UE policy container 520. The configuration update command 522 may indicate that a configuration of the UE 502 is to be updated.

The NAS entity 506 may receive the configuration update command 522 from the AMF 514. The NAS entity 506 may process the configuration update command 522 and determine URSP parameters for SON measurements based on the configuration updated command. The NAS entity 506 may transmit the URSP parameters for SON measurements 524 to the UE measurement client 508. The UE measurement client 508 may determine the URSP parameters for the SON measurements 524 and store the URSP parameters to be utilized for SON measurements performed by the UE 502.

The TCE 518 may provide a SON measurement configuration 526 to the base station 510. The SON measurement configuration 526 may include measurement parameters. The measurement parameters may define parameters to be included in a SON measurement performed by the UE 502.

The base station 510 may receive the SON measurement configuration 526 from the TCE 518. The base station 510 may determine the measurement parameters from the SON measurement configuration 526. The base station 510 may transmit a measurement configuration 528 to the RRC entity 504. The measurement configuration 528 may include the measurement parameters.

The RRC entity 504 may receive the measurement configuration 528 from the base station 510. The RRC entity 504 may determine the measurement parameters for SON measurements based on the measurement configuration 528. The RRC entity 504 may perform a SON measurement procedure 530 to produce measurement results. For example, the measurement results may comprise SON measurement results.

The RRC entity 504 may transmit a SON measurement results transmission 532 to the UE measurement client 508. The SON measurement results transmission 532 may include the measurement results of the SON measurement procedure 530. The UE measurement client 508 may process the SON measurement results transmission 532 to determine the measurement results of the SON measurement procedure 530.

The UE measurement client 508 may initiate data traffic in 534. Initiating the data traffic in 534 may include establishing a secure connection between the UE 502 and the TCE 518. The secure connection may be secured via the TLS. The UE measurement client 508 may transmit a SON measurement report 536 to the TCE 518 using the secure connection. The SON measurement report 536 may include the measurement results of the SON measurement procedure 530. In some embodiments, the UE measurement client 508 may provide the SON measurement report to the TCE 518 via upper layers.

Although, FIG. 5 may arguably imply an order of the operations and/or signals, it should be understood that one or more of the operations and/or signals may be performed in a different order and/or concurrently in other embodiments. Further, it should be understood that one or more of the operations and/or signals may be omitted and/or one or more additional operations and/or signals may be included in other embodiments.

In a second alternative of the third approach, the network may configure the SON measurement reporting through RRC Signaling (for example, originate from the base station). The PDU Session parameters for sending measurement results may be provisioned through RRC signaling. This may be something new for the modem to handle. PDU session parameters and measurement results may be provided from RRC to the upper layer (Meas Client).

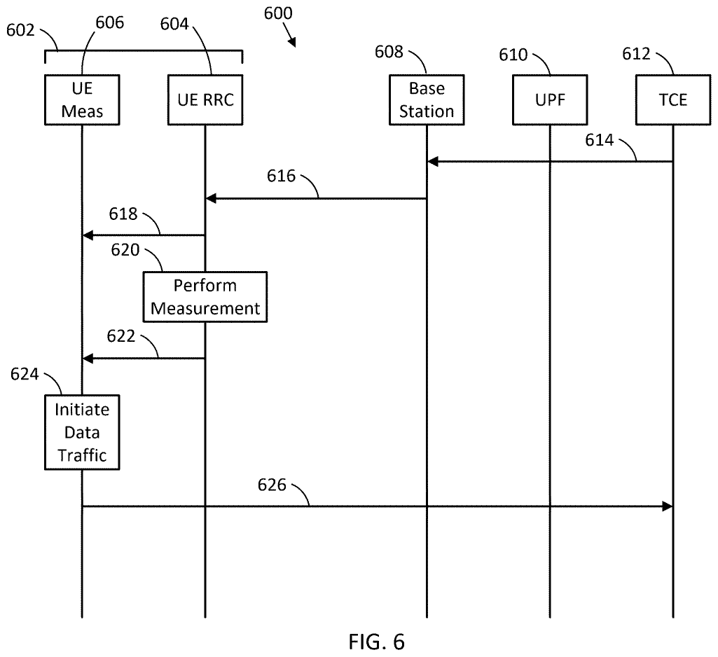

FIG. 6 illustrates an example signaling chart 600 for the second alternative of the third approach using RRC signaling in accordance with some embodiments. For example, the signaling chart 600 illustrates example entities and signals that may implement the second alternative of the third approach in accordance with some embodiments.

The signaling chart 600 may include a UE 602. The UE 602 may include one or more of the features of the first UE 102 (FIG. 1), the second UE 104 (FIG. 1), the UE 202 (FIG. 2), the first UE 302 (FIG. 3), the second UE 304 (FIG. 3), the UE 402 (FIG. 4), the UE 502 (FIG. 5) and/or the UE 1100 (FIG. 11). The signaling chart 600 illustrates portions of the UE 602. In particular, the signaling chart 600 illustrates a UE RRC entity 604 of the UE 602, and a UE measurement client 606 of the UE 602.

The signaling chart 600 may include a base station 608. The base station 608 may include one or more of the features of the base station 106 (FIG. 1), the base station 206 (FIG. 2), the base station 306 (FIG. 3), the base station 404 (FIG. 4), the base station 608 (FIG. 5) and/or the gNB 1200 (FIG. 12). In some embodiments, the base station 608 may comprise a gNB. The base station 608 may provide service to the UE 602, such that the UE 602 may communicate with a network that includes the base station 608 via the base station 608. The base station 608 may be part of an access network of the network, where the access network can provide access to the network for UEs (such as the UE 602).

The signaling chart 600 may include a UPF 610. The UPF 610 may include one or more of the features of the UPF 112 (FIG. 1), the UPF 208 (FIG. 2), the UPF 410 (FIG. 4), and/or the UPF 512 (FIG. 5).

The signaling chart may include a TCE 612. The TCE 612 may include one or more of the features of the SON server 416 (FIG. 4) and/or the TCE 518 (FIG. 5). The TCE 612 may collect trace information related to the network. The UPF 610 and/or the TCE 612 may be part of a core network of the network.

The TCE 612 may provide a SON measurement configuration 614 to the base station 608. The SON measurement configuration 614 may include measurement parameters and/or reporting parameters for SON measurements. The reporting parameters may include a server FQDN corresponding to the TCE 612 and/or PDU session parameters.

The base station 608 may receive the SON measurement configuration 614 from the TCE 612. The base station 608 may determine a measurement configuration for the UE 602 based on the SON measurement configuration 614 received from the TCE 612. The base station 608 may transmit a measurement configuration transmission 616 to the UE RRC entity 604. In some embodiments, the base station 608 may transmit the measurement configuration transmission 616 to the UE RRC entity 604 via RRC signaling. The measurement configuration transmission 616 may include the measurement parameters and/or reporting parameters from the SON measurement configuration 614.

The UE RRC entity 604 may receive the measurement configuration transmission 616 from the base station 608. The UE RRC entity 604 may determine parameters for performance of measurements. Further, the UE RRC entity 604 may determine a reporting configuration for SON measurements. The UE RRC entity 604 may provide a SON reporting configuration 618 to the UE measurement client 606. The SON reporting configuration 618 may include the server FQDN associated with the TCE 612 and/or PDU session parameters for reporting the SON measurements. The UE RRC entity 604 may perform a SON measurement procedure 620 to produce measurement results. For example, the measurement results may comprise SON measurement results.

The UE RRC entity 604 may transmit a SON measurement results transmission 622 to the UE measurement client 606. The SON measurement results transmission 622 may include the measurement results of the SON measurement procedure 620. The UE measurement client 606 may process the SON measurement results transmission 622 to determine the measurement results of the SON measurement procedure 620.

The UE measurement client 606 may initiate data traffic in 624. Initiating the data traffic in 624 may include establishing a secure connection between the UE 602 and the TCE 612. Further, the UE 602 may establish a PDU session via the secure connection. The secure connection may be secured via the TLS. The UE measurement client 606 may transmit a SON measurement report 626 to the TCE 612 using the secure connection. The SON measurement report 626 may include the measurement results of the SON measurement procedure 620. In some embodiments, the UE measurement client 606 may provide the SON measurement report to the TCE 612 as part of the PDU session via the secure connection.

Although, FIG. 6 may arguably imply an order of the operations and/or signals, it should be understood that one or more of the operations and/or signals may be performed in a different order and/or concurrently in other embodiments. Further, it should be understood that one or more of the operations and/or signals may be omitted and/or one or more additional operations and/or signals may be included in other embodiments.

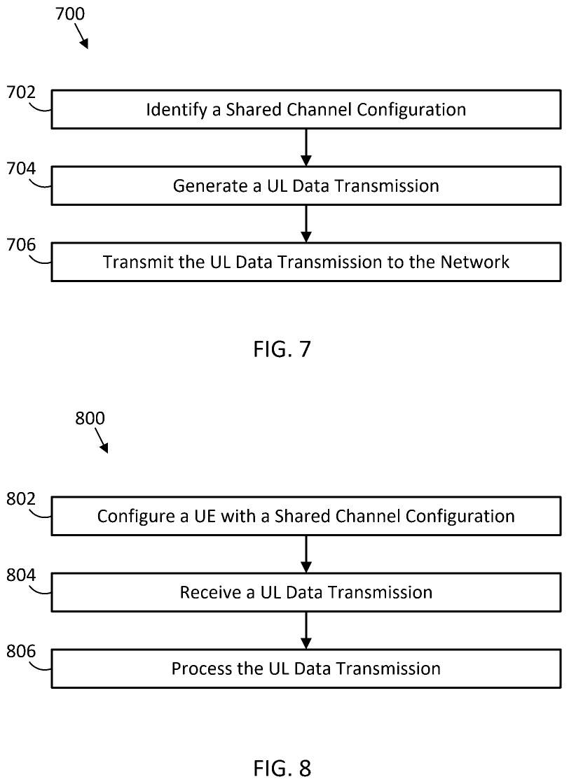

FIG. 7 illustrates an example procedure 700 for operating a UE in accordance with some embodiments. For example, the procedure 700 illustrates a plurality of operations that may be performed by a UE (such as the first UE 102 (FIG. 1), the second UE 104 (FIG. 1), the UE 202 (FIG. 2), the first UE 302 (FIG. 3), the second UE 304 (FIG. 3), the UE 402 (FIG. 4), the UE 502 (FIG. 5), the UE 602 (FIG. 6), and/or the UE 1100 (FIG. 11)). The procedure 700 may be performed as part of the first approach and/or the second approach, as described throughout this disclosure, in some embodiments.

The procedure 700 may include identifying a shared channel configuration in 702. For example, the UE may identify a shared channel configuration (such as the configurations for the first approach and/or the second approach as described throughout this disclosure) to configure a shared channel for transmission of UL data. The shared channel may be available for two or more UEs. In some embodiments, the shared channel may comprise a shared N3 tunnel located between a base station receiving a UL data transmissions from the UE and a UPF of a network.

In some embodiments, the shared channel may extend between the two or more UEs and a base station of the network. The shared channel configuration may comprise a C-RNTI corresponding to the shared channel in some embodiments. The common C-RNTI may be utilized by the two or more UEs for transmission via the shared channel.

In some embodiments, the shared channel configuration may comprise a UE-ID corresponding to the shared channel. The UE-ID may be utilized by the two or more UEs for transmission via the shared channel. Further, the shared channel may comprise a first C-RNTI for normal transmissions and one or more additional C-RNTIs for transmissions to be transmitted via the shared channel in some embodiments.

In some embodiments, the shared channel configuration may comprise a mask to be utilized for transmissions via the shared channel. The mask may comprise a key of asymmetric cryptography or symmetric cryptography.

The procedure 700 may include generating a UL data transmission in 704. For example, the UE may generate a UL data transmission to be anonymously transmitted to a network (such as the anonymized UL data transmissions described throughout this disclosure). In some embodiments, the UL data transmission may comprise location information for the UE and/or measurement results of the UE. Further, generating the UL data transmission may comprise generating the UL data transmission with a source IP address blank or a randomized IP address assigned to a source IP address field.

The procedure 700 may include transmitting the UL data transmission to the network in 706. For example, the UE may transmit the UL data transmission to the network in accordance with the shared channel configuration. In some embodiments, transmitting the UL data transmission may comprise transmitting the UL data transmission without UE-identifying information or with UE-identifying information to be removed by a base station receiving the UL data transmission. Further, transmitting the UL data transmission may comprise transmitting the UL data transmission via a DRM associated with the shared channel in some embodiments.

In some embodiments, transmitting the UL data transmission may comprise establishing a dedicated PDU session with the base station in accordance with the shared channel configuration. The dedicated PDU session may be used for anonymized UL traffic.

Further, transmitting the UL data transmission may comprise transmitting the UL data transmission via the dedicated PDU session.

Although, FIG. 7 may arguably imply an order of the operations of the procedure 700, it should be understood that one or more of the operations may be performed in a different order and/or concurrently in other embodiments. Further, it should be understood that one or more of the operations may be omitted and/or one or more additional operations may be included in other embodiments.

FIG. 8 illustrates an example procedure 800 for operating a base station in accordance with some embodiments. For example, the procedure 800 illustrates a plurality of operations that may be performed by a base station (such as the base station 106 (FIG. 1), the base station 206 (FIG. 2), the base station 306 (FIG. 3), the base station 404 (FIG. 4), the base station 510 (FIG. 5), the base station 608 (FIG. 6), and/or the gNB 1200 (FIG. 12)). The procedure 800 may be performed as part of the first approach and/or the second approach, as described throughout this disclosure, in some embodiments.

The procedure 800 may include configuring a UE with a shared channel configuration in 802. For example, the base station may configure the UE with a shared channel configuration (such as the configurations for the first approach and/or the second approach as described throughout this disclosure) for a shared channel maintained by the base station. The shared channel may be available for two or more UEs.

In some embodiments, configuring the UE may comprise providing PDU session information to the UE via URSP. Further, configuring the UE may comprise providing information of the shared channel configuration via control plane signaling (for example, RRC signaling) to the UE in some embodiments.

In some embodiments, configuring the UE may comprise configuring the UE with a common C-RNTI corresponding to the shared channel. The common C-RNTI may be configured to the two or more UEs. Further, configuring the UE may comprise configuring the UE with a UE-ID corresponding to the shared channel in some embodiments. The UE-ID may be configured to two or more UEs. In some embodiments, configuring the UE may comprise configuring the UE with a first C-RNTI for normal transmissions and one or more additional C-RNTIs for transmissions to be transmitted via the shared channel.

In some embodiments, configuring the UE may comprise configuring the UE with a mask to be utilized for transmissions via the shared channel. The mask may comprise a key of asymmetric cryptography or symmetric cryptography.

The procedure 800 may include receiving a UL data transmission in 804. For example, the base station may receive a UL data transmission from the UE to be transmitted anonymously to a network element (such as the NF 120 (FIG. 1) and/or the server 214 (FIG. 2)). In some embodiments, the shared channel extends between the UE and the base station, where the UL data transmission is received from the UE via the shared channel.

The procedure 800 may include processing the UL data transmission in 806. For example, the base station may process the UL data transmission in accordance with the shared channel configuration.

In some embodiments, the network element may comprise a network function of the network. The base station may further set up a shared N3 tunnel between the base station and the network function. The shared N3 tunnel may be utilized for providing anonymized UL data transmissions from two or more UEs to the network function. In some embodiments, processing the UL data transmission comprises transmitting the UL data transmission via the shared N3 tunnel.

In some embodiments, processing the UL data transmission may comprise identifying a source IP address within the UL data transmission. Further, processing the UL data transmission may comprise replacing the source IP address with an IP address of the base station.

Although, FIG. 8 may arguably imply an order of the operations of the procedure 800, it should be understood that one or more of the operations may be performed in a different order and/or concurrently in other embodiments. Further, it should be understood that one or more of the operations may be omitted and/or one or more additional operations may be included in other embodiments.

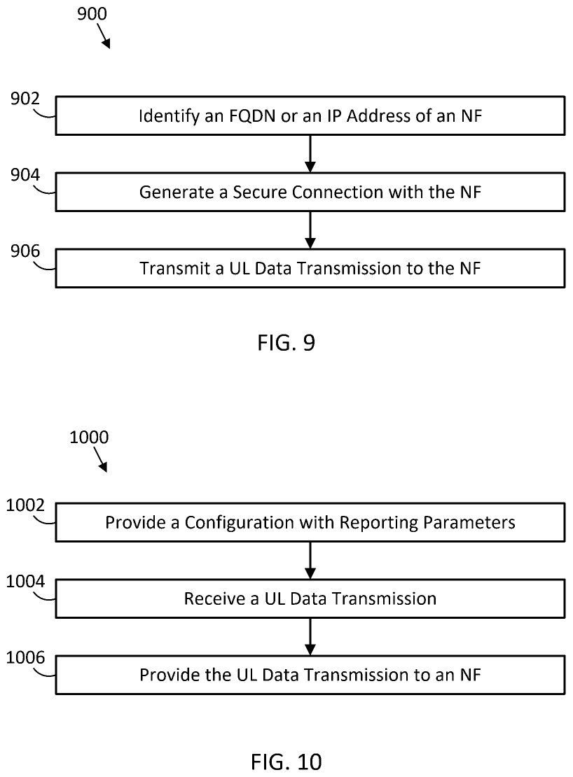

FIG. 9 illustrates an example procedure 900 for operating a UE in accordance with some embodiments. For example, the procedure 900 illustrates a plurality of operations that may be performed by a UE (such as the first UE 102 (FIG. 1), the second UE 104 (FIG. 1), the UE 202 (FIG. 2), the first UE 302 (FIG. 3), the second UE 304 (FIG. 3), the UE 402 (FIG. 4), the UE 502 (FIG. 5), the UE 602 (FIG. 6), and/or the UE 1100 (FIG. 11)). The procedure 900 may be performed as part of the third approach, as described throughout this disclosure, in some embodiments.

The procedure 900 may include identifying an FQDN or an IP address of an NF in 902. For example, the UE may identify an FQDN or an IP address of an NF of a network that is to request information from the UE. In some embodiments, the NF may comprise a SON server. The SON server may comprise a TCE in some embodiments.

In some embodiments, the FQDN or the IP address may be received via URSP parameters. The URSP parameters may include PDU session parameters for a secure connection in some embodiments.

In some embodiments, the FQDN or the IP address may be received via RRC signaling. The RRC signaling may include PDU session parameters for a secure connection in some embodiments.

The procedure 900 may include generating a secure connection with the NF in 904. For example, the UE may generate a secure connection with the NF using the FQDN or the IP address. The secure connection may utilize TLS. The TLS may prevent a UPF of the network from accessing data within a UL data transmission in some embodiments.

The procedure 900 may include transmitting a UL data transmission to the NF in 906. For example, the base station may transmit a UL data transmission to the NF using the secure connection. The UL data transmission may utilize the TLS.

In some embodiments, the UE may further perform measurements to produce measurement results for the NF. The UL data transmission may comprise the measurement results.

Although, FIG. 9 may arguably imply an order of the operations of the procedure 900, it should be understood that one or more of the operations may be performed in a different order and/or concurrently in other embodiments. Further, it should be understood that one or more of the operations may be omitted and/or one or more additional operations may be included in other embodiments.

FIG. 10 illustrates an example procedure 1000 for operating a base station in accordance with some embodiments. For example, the procedure 1000 illustrates a plurality of operations that may be performed by a base station (such as the base station 106 (FIG. 1), the base station 206 (FIG. 2), the base station 306 (FIG. 3), the base station 404 (FIG. 4), the base station 510 (FIG. 5), the base station 608 (FIG. 6), and/or the gNB 1200 (FIG. 12)). The procedure 1000 may be performed as part of the third approach, as described throughout this disclosure, in some embodiments.

The procedure 1000 may include providing a configuration with reporting parameters in 1002. For example, the base station may provide a configuration with reporting parameters to a UE. The reporting parameters may include information for establishing a secure connection using TLS with an NF of a network to which the UE is to provide a measurement report. In some embodiments, the NF may comprise an SON server. Further, the SON server may comprise a TCE in some embodiments. In some embodiments, the information of the reporting parameters may comprise an FQDN or an IP address of the NF.

In some embodiments, the information of the reporting parameters may comprise URSP parameters. The URSP parameters may include PDU parameters for the secure connection in some embodiments.

In some embodiments, the configuration may be provided via RRC signaling. The RRC signaling may include PDU parameters for the secure connection.

The procedure 1000 may include receiving a UL data transmission in 1004. For example, the base station may receive a UL data transmission from the UE. The UL data transmission may include the measurement report.

The procedure 1000 may include providing the UL data transmission to the NF in 1006. For example, the base station may provide the UL data transmission to the NF via a UPF of the network. The UPF may be unable to access the UL data transmission.

Although, FIG. 10 may arguably imply an order of the operations of the procedure 1000, it should be understood that one or more of the operations may be performed in a different order and/or concurrently in other embodiments. Further, it should be understood that one or more of the operations may be omitted and/or one or more additional operations may be included in other embodiments.

FIG. 11 illustrates an example UE 1100 in accordance with some embodiments. The UE 1100 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices. In some embodiments, the UE 1100 may be a RedCap UE or NR-Light UE.

The UE 1100 may include processors 1104, RF interface circuitry 1108, memory/storage 1112, user interface 1116, sensors 1120, driver circuitry 1122, power management integrated circuit (PMIC) 1124, antenna structure 1126, and battery 1128. The components of the UE 1100 may be implemented as integrated circuits (ICs), portions thereof, discrete electronic devices, or other modules, logic, hardware, software, firmware, or a combination thereof. The block diagram of FIG. 11 is intended to show a high-level view of some of the components of the UE 1100. However, some of the components shown may be omitted, additional components may be present, and different arrangement of the components shown may occur in other implementations.

The components of the UE 1100 may be coupled with various other components over one or more interconnects 1132, which may represent any type of interface, input/output, bus (local, system, or expansion), transmission line, trace, optical connection, etc. that allows various circuit components (on common or different chips or chipsets) to interact with one another.

The processors 1104 may include processor circuitry such as, for example, baseband processor circuitry (BB) 1104A, central processor unit circuitry (CPU) 1104B, and graphics processor unit circuitry (GPU) 1104C. The processors 1104 may include any type of circuitry or processor circuitry that executes or otherwise operates computer-executable instructions, such as program code, software modules, or functional processes from memory/storage 1112 to cause the UE 1100 to perform operations as described herein.

In some embodiments, the baseband processor circuitry 1104A may access a communication protocol stack 1136 in the memory/storage 1112 to communicate over a 3GPP compatible network. In general, the baseband processor circuitry 1104A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 1108.

The baseband processor circuitry 1104A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 1112 may include one or more non-transitory, computer-readable media that includes instructions (for example, communication protocol stack 1136) that may be executed by one or more of the processors 1104 to cause the UE 1100 to perform various operations described herein. The memory/storage 1112 include any type of volatile or non-volatile memory that may be distributed throughout the UE 1100. In some embodiments, some of the memory/storage 1112 may be located on the processors 1104 themselves (for example, L1 and L2 cache), while other memory/storage 1112 is external to the processors 1104 but accessible thereto via a memory interface. The memory/storage 1112 may include any suitable volatile or non-volatile memory such as, but not limited to, dynamic random access memory (DRAM), static random access memory (SRAM), eraseable programmable read only memory (EPROM), electrically eraseable programmable read only memory (EEPROM), Flash memory, solid-state memory, or any other type of memory device technology.

The RF interface circuitry 1108 may include transceiver circuitry and radio frequency front module (RFEM) that allows the UE 1100 to communicate with other devices over a radio access network. The RF interface circuitry 1108 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 1126 and proceed to filter and amplify (with a low-noise amplifier) the signal. The signal may be provided to a receiver of the transceiver that down-converts the RF signal into a baseband signal that is provided to the baseband processor of the processors 1104.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1126.

In various embodiments, the RF interface circuitry 1108 may be configured to transmit/receive signals in a manner compatible with NR access technologies.

The antenna 1126 may include antenna elements to convert electrical signals into radio waves to travel through the air and to convert received radio waves into electrical signals. The antenna elements may be arranged into one or more antenna panels. The antenna 1126 may have antenna panels that are omnidirectional, directional, or a combination thereof to enable beamforming and multiple input, multiple output communications. The antenna 1126 may include microstrip antennas, printed antennas fabricated on the surface of one or more printed circuit boards, patch antennas, phased array antennas, etc. The antenna 1126 may have one or more panels designed for specific frequency bands including bands in FR1 or FR2.

The user interface circuitry 1116 includes various input/output (I/O) devices designed to enable user interaction with the UE 1100. The user interface 1116 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 1100.

The sensors 1120 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1122 may include software and hardware elements that operate to control particular devices that are embedded in the UE 1100, attached to the UE 1100, or otherwise communicatively coupled with the UE 1100. The driver circuitry 1122 may include individual drivers allowing other components to interact with or control various input/output (I/O) devices that may be present within, or connected to, the UE 1100. For example, driver circuitry 1122 may include a display driver to control and allow access to a display device, a touchscreen driver to control and allow access to a touchscreen interface, sensor drivers to obtain sensor readings of sensor circuitry 1120 and control and allow access to sensor circuitry 1120, drivers to obtain actuator positions of electro-mechanic components or control and allow access to the electro-mechanic components, a camera driver to control and allow access to an embedded image capture device, audio drivers to control and allow access to one or more audio devices.

The PMIC 1124 may manage power provided to various components of the UE 1100. In particular, with respect to the processors 1104, the PMIC 1124 may control power-source selection, voltage scaling, battery charging, or DC-to-DC conversion.

In some embodiments, the PMIC 1124 may control, or otherwise be part of, various power saving mechanisms of the UE 1100. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1100 may power down for brief intervals of time and thus save power. If there is no data traffic activity for an extended period of time, then the UE 1100 may transition off to an RRC_Idle state, where it disconnects from the network and does not perform operations such as channel quality feedback, handover, etc. The UE 1100 goes into a very low power state and it performs paging where again it periodically wakes up to listen to the network and then powers down again. The UE 1100 may not receive data in this state; in order to receive data, it must transition back to RRC Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1128 may power the UE 1100, although in some examples the UE 1100 may be mounted deployed in a fixed location, and may have a power supply coupled to an electrical grid. The battery 1128 may be a lithium ion battery, a metal-air battery, such as a zinc-air battery, an aluminum-air battery, a lithium-air battery, and the like. In some implementations, such as in vehicle-based applications, the battery 1128 may be a typical lead-acid automotive battery.

FIG. 12 illustrates an example gNB 1200 in accordance with some embodiments. The gNB 1200 may include processors 1204, RF interface circuitry 1208, core network (CN) interface circuitry 1212, memory/storage circuitry 1216, and antenna structure 1226.

The components of the gNB 1200 may be coupled with various other components over one or more interconnects 1228.

The processors 1204, RF interface circuitry 1208, memory/storage circuitry 1216 (including communication protocol stack 1210), antenna structure 1226, and interconnects 1228 may be similar to like-named elements shown and described with respect to FIG. 11.

The CN interface circuitry 1212 may provide connectivity to a core network, for example, a 5th Generation Core network (5GC) using a 5GC-compatible network interface protocol such as carrier Ethernet protocols, or some other suitable protocol. Network connectivity may be provided to/from the gNB 1200 via a fiber optic or wireless backhaul. The CN interface circuitry 1212 may include one or more dedicated processors or FPGAs to communicate using one or more of the aforementioned protocols. In some implementations, the CN interface circuitry 1212 may include multiple controllers to provide connectivity to other networks using the same or different protocols.

As described above, one aspect of the present technology is the gathering and use of data available from specific and legitimate sources to be utilized for determining proper operation of a communications network. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used for operation of communication systems. For example, the personal information data can be used for determining proper operation of a communication system for providing service to a device of a user. For instance, a location of a device of a user may be utilized for determining a power of signals to be transmitted to the device, antennas to be utilized for transmitting signals to the device, beams to be utilized for transmitting signals to the device, or some combination thereof.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in providing location information of the device. In another example, users can select not to provide location information related to the device. In yet another example, users can select to limit the uses of location information. In addition to providing “opt in” and “opt out” options, the present disclosure contemplates providing notifications relating to the access or use of personal information.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users based on aggregated non-personal information data or a bare minimum amount of personal information, such as the content being handled only on the user's device or other non-personal information available to the content delivery services.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 may include a method of operating a user equipment (UE), comprising identifying a shared channel configuration to configure a shared channel for transmission of uplink (UL) data, the shared channel to be available for two or more UEs, generating a UL data transmission to be anonymously transmitted to a network, and transmitting the UL data transmission to the network in accordance with the shared channel configuration.

Example 2 may include the method of example 1, wherein the UL data transmission comprises location information for the UE or measurement results of the UE, and transmitting the UL data transmission comprises transmitting the UL data transmission without UE-identifying information or with UE-identifying information to be removed by a base station receiving the UL data transmission.

Example 3 may include the method of example 1, wherein the shared channel comprises a shared N3 tunnel located between a base station receiving the UL data transmission and a user plane function (UPF) of the network.

Example 4 may include the method of example 3, wherein transmitting the UL data transmission comprises establishing a dedicated protocol data unit (PDU) session with the base station in accordance with the shared channel configuration, the dedicated PDU session to be used for anonymized UL traffic, and transmitting the UL data transmission via the dedicated PDU session.

Example 5 may include the method of example 3, wherein generating the UL data transmission comprises generating the UL data transmission with a source internet protocol (IP) address blank or a randomized IP address assigned to a source IP address field.

Example 6 may include the method of example 3, wherein transmitting the UL data transmission comprises transmitting the UL data transmission via a data radio bearer (DRB) associated with the shared channel.

Example 7 may include the method of example 1, wherein the shared channel extends between the two or more UEs and a base station of the network.

Example 8 may include the method of example 7, wherein the shared channel configuration comprises a common cell radio network temporary identifier (C-RNTI) corresponding to the shared channel, the common C-RNTI to be utilized by the two or more UEs for transmission via the shared channel.

Example 9 may include the method of example 7, wherein the shared channel configuration comprises a UE-identifier (ID) corresponding to the shared channel, the UE-ID to be utilized by the two or more UEs for transmission via the shared channel.

Example 10 may include the method of example 7, wherein the shared channel configuration comprises a first cell radio network temporary identifier (C-RNTI) for normal transmissions and one or more additional C-RNTIs for transmissions to be transmitted via the shared channel.

Example 11 may include the method of example 7, wherein the shared channel configuration comprises a mask to be utilized for transmissions via the shared channel.

Example 12 may include the method of example 11, wherein the mask comprises a key of asymmetric cryptography or symmetric cryptography.

Example 13 may include a method of operating a base station, comprising configuring a user equipment (UE) with a shared channel configuration for a shared channel maintained by the base station, the shared channel to be available for two or more UEs, receiving an uplink (UL) data transmission from the UE to be transmitted anonymously to a network element, and processing the UL data transmission in accordance with the shared channel configuration.

Example 14 may include the method of example 13, wherein configuring the UE comprises providing protocol data unit (PDU) session information to the UE via UE route selection policy (URSP).

Example 15 may include the method of example 13, wherein configuring the UE comprises providing information of the shared channel configuration via control plane signaling to the UE.

Example 16 may include the method of example 13, wherein the network element comprises a network function of a network, and wherein the method further comprises setting up a shared N3 tunnel between the base station and the network function, the shared N3 tunnel to be utilized for providing anonymized UL data transmissions from two or more UEs to the network function.

Example 17 may include the method of example 16, wherein processing the UL data transmission comprises transmitting the UL data transmission via the shared N3 tunnel.

Example 18 may include the method of example 16, wherein processing the UL data transmission comprises identifying a source internet protocol (IP) address within the UL data transmission, and replacing the source IP address with an IP address of the base station.

Example 19 may include the method of example 13, wherein the shared channel extends between the UE and the base station, and wherein the UL data transmission is received from the UE via the shared channel.

Example 20 may include the method of example 19, wherein configuring the UE comprises configuring the UE with a common cell radio network temporary identifier (C-RNTI) corresponding to the shared channel, the common C-RNTI to be configured to the two or more UEs.

Example 21 may include the method of example 19, wherein configuring the UE comprises configuring the UE with a UE-identifier (ID) corresponding to the shared channel, the UE-ID to be configured to two or more UEs.

Example 22 may include the method of example 19, wherein configuring the UE comprises configuring the UE with a first cell radio network temporary identifier (C-RNTI) for normal transmissions and one or more additional C-RNTIs for transmissions to be transmitted via the shared channel.

Example 23 may include the method of example 19, wherein configuring the UE comprises configuring the UE with a mask to be utilized for transmissions via the shared channel.

Example 24 may include the method of example 23, wherein the mask comprises a key of asymmetric cryptography or symmetric cryptography.

Example 25 may include a method of operating a user equipment (UE), comprising identifying a fully qualified domain name (FQDN) or an internet protocol (IP) address of a network function (NF) of a network that is to request information from the UE, generating a secure connection with the NF using the FQDN or the IP address, the secure connection utilizing transport layer security (TLS), and transmitting an uplink (UL) data transmission to the NF using the secure connection, the UL data transmission utilizing the TLS.

Example 26 may include the method of example 25, wherein the NF comprises a self-organizing network (SON) server.

Example 27 may include the method of example 26, wherein the SON server comprises a trace collection entity.

Example 28 may include the method of example 25, further comprising performing measurements to produce measurement results for the NF, wherein the UL data transmission comprises the measurement results.

Example 29 may include the method of example 25, wherein the TLS prevents a user plane function (UPF) of the network from accessing data within the UL data transmission.

Example 30 may include the method of example 25, wherein the FQDN or the IP address is received via UE route selection policy (URSP) parameters.

Example 31 may include the method of example 30, wherein the URSP parameters include protocol data unit (PDU) session parameters for the secure connection.

Example 32 may include the method of example 25, wherein the FQDN or the IP address is received via radio resource control (RRC) signaling.

Example 33 may include the method of example 32, wherein the RRC signaling includes protocol data unit (PDU) session parameters for the secure connection.

Example 34 may include a method of operating a base station, comprising providing a configuration with reporting parameters to a user equipment (UE), the reporting parameters including information for establishing a secure connection using transport layer security (TLS) with a network function (NF) of a network to which the UE is to provide a measurement report, receiving an uplink (UL) data transmission from the UE, the UL data transmission including the measurement report, and providing the UL data transmission to the NF via a user plane function (UPF) of the network, the UPF unable to access the UL data transmission.

Example 35 may include the method of example 34, wherein the NF comprises a self-organizing network (SON) server.

Example 36 may include the method of example 35, wherein the SON server comprises a trace collection entity.

Example 37 may include the method of example 34, wherein the information comprises a fully qualified domain name (FQDN) or an internet protocol (IP) address of the NF.

Example 38 may include the method of example 34, wherein the information comprises UE route selection policy (URSP) parameters.

Example 39 may include the method of example 38, wherein the URSP parameters include protocol data unit (PDU) parameters for the secure connection.

Example 40 may include the method of example 34, wherein the configuration is provided via radio resource control (RRC) signaling.

Example 41 may include the method of example 40, wherein the RRC signaling includes protocol data unit (PDU) parameters for the secure connection.

Example 42 may include an apparatus comprising means to perform one or more elements of a method described in or related to any of examples 1-41, or any other method or process described herein.

Example 43 may include one or more non-transitory computer-readable media comprising instructions to cause an electronic device, upon execution of the instructions by one or more processors of the electronic device, to perform one or more elements of a method described in or related to any of examples 1-41, or any other method or process described herein.

Example 44 may include an apparatus comprising logic, modules, or circuitry to perform one or more elements of a method described in or related to any of examples 1-41, or any other method or process described herein.

Example 45 may include a method, technique, or process as described in or related to any of examples 1-41, or portions or parts thereof.

Example 46 may include an apparatus comprising: one or more processors and one or more computer-readable media comprising instructions that, when executed by the one or more processors, cause the one or more processors to perform the method, techniques, or process as described in or related to any of examples 1-41, or portions thereof.

Example 47 may include a signal as described in or related to any of examples 1-41, or portions or parts thereof.

Example 48 may include a datagram, information element, packet, frame, segment, PDU, or message as described in or related to any of examples 1-41, or portions or parts thereof, or otherwise described in the present disclosure.

Example 49 may include a signal encoded with data as described in or related to any of examples 1-41, or portions or parts thereof, or otherwise described in the present disclosure.

Example 50 may include a signal encoded with a datagram, IE, packet, frame, segment, PDU, or message as described in or related to any of examples 1-41, or portions or parts thereof, or otherwise described in the present disclosure.

Example 51 may include an electromagnetic signal carrying computer-readable instructions, wherein execution of the computer-readable instructions by one or more processors is to cause the one or more processors to perform the method, techniques, or process as described in or related to any of examples 1-41, or portions thereof.

Example 52 may include a computer program comprising instructions, wherein execution of the program by a processing element is to cause the processing element to carry out the method, techniques, or process as described in or related to any of examples 1-41, or portions thereof.

Example 53 may include a signal in a wireless network as shown and described herein.

Example 54 may include a method of communicating in a wireless network as shown and described herein.

Example 55 may include a system for providing wireless communication as shown and described herein.

Example 56 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1-20. (canceled)

21. A method comprising:
identifying a shared channel configuration to configure a shared channel for transmission of uplink (UL) data, the shared channel to be available for two or more user equipments (UEs); and
generating, for transmission to a network in accordance with the shared channel configuration, a UL data transmission to be anonymously transmitted to the network.

22. The method of claim 21, wherein:
the UL data transmission comprises location information for a user equipment (UE) or measurement results of the UE; and
the UL data transmission is for transmission without UE-identifying information or with UE-identifying information to be removed by a base station receiving the UL data transmission.

23. The method of claim 21, wherein the shared channel comprises a shared N3 tunnel located between a base station receiving the UL data transmission and a user plane function (UPF) of the network.

24. The method of claim 23, wherein transmission of the UL data transmission to the network comprises:
establishing a dedicated protocol data unit (PDU) session with the base station in accordance with the shared channel configuration, the dedicated PDU session to be used for anonymized UL traffic, wherein the UL data transmission is to be transmitted via the dedicated PDU session.

25. The method of claim 21, wherein the shared channel extends between the two or more UEs and a base station of the network.

26. The method of claim 25, wherein the shared channel configuration comprises a common cell radio network temporary identifier (C-RNTI) corresponding to the shared channel, the common C-RNTI to be utilized by the two or more UEs for transmission via the shared channel.

27. The method of claim 25, wherein the shared channel configuration comprises a first cell radio network temporary identifier (C-RNTI) for normal transmissions and one or more additional C-RNTIs for transmissions to be transmitted via the shared channel.

28. The method of claim 25, wherein the shared channel configuration comprises a mask to be utilized for transmissions via the shared channel.

29. The method of claim 28, wherein the mask comprises a key of asymmetric cryptography or symmetric cryptography.

30. A method, comprising:
generating, for transmission to a user equipment (UE), a shared channel configuration for a shared channel maintained by a base station, the shared channel to be available for two or more user equipments (UEs);
receiving an uplink (UL) data transmission from the UE to be transmitted anonymously to a network element; and
processing the UL data transmission in accordance with the shared channel configuration.

31. The method of claim 30, wherein generating the shared channel configuration includes generating, for provision to the UE via UE route selection policy, protocol data unit (PDU) session information.

32. The method of claim 30, wherein generating the shared channel configuration comprises generating, for provision to the UE via control plane signaling, information of the shared channel configuration.

33. The method of claim 30, wherein the network element comprises a network function of a network, and wherein the method further comprises:
setting up a shared N3 tunnel between the base station and the network function, the shared N3 tunnel to be utilized for providing anonymized UL data transmissions from two or more UEs to the network function.

34. The method of claim 33, wherein processing the UL data transmission comprises forwarding the UL data transmission via the shared N3 tunnel.

35. The method of claim 30, wherein the shared channel extends between the UE and the base station, and wherein the UL data transmission is received from the UE via the shared channel.

36. The method of claim 35, wherein the shared channel configuration includes a UE-identifier (ID) corresponding to the shared channel for configuration of the UE, the UE-ID to be configured to two or more UEs.

37. An apparatus, comprising:
processing circuitry to:
identify a fully qualified domain name (FQDN) or an internet protocol (IP) address of a network function (NF) of a network that is to request information from a user equipment (UE); and
generate a secure connection with the NF using the FQDN or the IP address, the secure connection utilizing transport layer security (TLS), wherein an uplink (UL) data transmission utilizing the TLS is to be transmitted to the NF using the secure connection; and
interface circuitry to transmit the UL data transmission.

38. The apparatus of claim 37, wherein the NF comprises a self-organizing network (SON) server.

39. The apparatus of claim 37, wherein the FQDN or the IP address is received via UE route selection policy (URSP) parameters.

40. The apparatus of claim 37, wherein the FQDN or the IP address is received via radio resource control (RRC) signaling.
